(19) United States
(12) Patent Application Publication
(10) Pub. No.: US 2015/0043444 A1
(43) Pub. Date: Feb. 12, 2015

(54) CONCURRENT DEVICE TO DEVICE AND CELLULAR COMMUNICATION METHOD WITH MULTIPLE ANTENNAS, USER EQUIPMENT USING THE SAME, BASE STATION USING THE SAME AND COMMUNICATION SYSTEM USING THE SAME

(71) Applicant: ACER INCORPORATED, New Taipei City (TW)

(72) Inventor: Hung-Yu Wei, New Taipei City (TW)

(21) Appl. No.: 14/300,244

(22) Filed: Jun. 10, 2014

Related U.S. Application Data
(60) Provisional application No. 61/864,650, filed on Aug. 12, 2013.

(51) Int. Cl. H04B 7/06; H04B 7/04

(52) U.S. Cl. CPC H04B 7/0621; H04B 7/0413
USPC 370/329

(57) ABSTRACT

The present disclosure proposes a device to device (D2D) communication method which would include a base station establishing a cellular connection with a first UE, a second UE establishing a device to device (D2D) connection with a third UE, the base station transmits a transmission configuration to the second UE, the base station transmits a first wireless signal to the first UE through the cellular connection and the second UE transmits to the third UE a second wireless signal through the D2D connection using the multiple antennas, wherein the first wireless signal and the second wireless signal are transmitted over the same resource, and the second UE performing interference cancellation of the first wireless signal and the second wireless signal based on the received transmission configuration from the cellular network device.

### CROSS REFERENCE TO RELATED APPLICATION

This application claims the priority benefit of U.S.A. provisional application Ser. No. 61/864,650, filed on Aug. 12, 2013. The entirety of the above-mentioned patent application is hereby incorporated by reference herein and made a part of specification.

### TECHNICAL FIELD

The present disclosure directs to a concurrent device to device (D2D) and cellular communication method with multiple antennas, a user equipment using the same method, a base station using the same method, and a communication system using the same method.

### RELATED ART

Recently, physical layer wireless transmission technologies have been greatly improved by multiple-antenna based system designs such as the multiple-input multiple-output (MIMO) antenna technology. The MIMO technology could be characterized by the use of multiple antennas both at a transmitter side and a receiver side in order to improve the overall system performance by spreading the total transmitted power over the antennas to achieve an array gain and a diversity gain. Thus MIMO technology thus has been adopted as a part of a wireless communication system such as the 3GPP Long Term Evolution (LTE) wireless communication system.

However, for a current 3GPP wireless communication system, even though multiple antenna transmission techniques such as MIMO, interference nulling, and interference alignment have been used to enhance transmission efficiency, multiple antenna transmission techniques for device-to-device (D2D) communications, or wireless peer-to-peer (P2P) communications, have not been adopted in the LTE standard nor adopted in the Proximity Services (ProSe) standard which is the LTE version of device-to-device communications or direct communications.

FIG. 1A illustrates conventional cellular communications is between a base station 101 and a user equipment (UE) 102 which transmits uplink signals and receive downlink signals wirelessly from the base station 101. The base station 101 could then be connected to a core network through a radio controller (not shown) over a backhaul link so as to connect a UE 102 to the core network through the base station 101. In the case of LTE, an evolved Node B (eNB) would perform the functions of the base station 101 and the radio controller. FIG. 1B illustrates D2D (device-to-device) communications also known as peer to peer communication between a first UE 103 and a second UE 104. The first UE 103 would directly transmit wireless data to the second UE 104 and directly receive wireless data from the second UE 104 without requiring a base station or eNB to continuously deliver the wireless data from one UE to the other UE in between.

If a conventional cellular communication such as one shown in FIG. 1A and a D2D type of communication such as the one shown in FIG. 1B were to co-exist in the same resource, a radio resource allocation strategy would need to be applied in order to avoid interferences between the cellular communication and the D2D communication. For example, the resource allocation strategy could be to allocate a frequency resource such as a frequency carrier, a subcarrier, or a subband for the cellular communication, and a different frequency carrier, a different subcarrier, or a different subband for the D2D communication. Another resource allocation strategy could be to schedule different time slots for the D2D communication and the cellular communication. Another resource allocation strategy could be the combination of the above by allocating different time and frequency resources for both the D2D communication and the cellular communication.

However, there is currently no mean to incorporate the use of multi-antennas technology in the field of D2D communication among peer devices, and thus there is no specific resource allocation strategy devised to differentiate between D2D communication and cellular application in order to solve problems which would arise from the application of multi-antennas and the D2D mode of communication in combination.

### SUMMARY OF THE DISCLOSURE

Accordingly, the present disclosure proposes a concurrent cellular and device to device (D2D) communication method with multiple antennas applicable for a user equipment, a base station, and a communication system.

The present disclosure proposes a concurrent cellular and device to device (D2D) communication method applicable to a user equipment (UE) having multiple antennas, and the method would include at least but not limited to the UE establishing a cellular connection with a cellular network device such as a base station and also establishing a D2D connection with another user equipment. The UE would receive a transmission configuration from the cellular network device. The UE would receive a first wireless signal through the cellular connection and a second wireless signal through the D2D connection using the multiple antennas, wherein the first wireless signal and the second wireless signal are received over the same resource such as over the same frequency band or carrier. The UE would perform interference cancellation of the first wireless signal and the second wireless signal based on the information from the received transmission configuration from the cellular network device.

According to one of the exemplary embodiments, before the UE would receive the transmission configuration from the cellular network device, the UE would measure a first multiple-input multiple-output (MIMO) antenna channel between the UE and the cellular network device to obtain a cellular channel matrix, the UE would also measure a second MIMO antenna channel between the UE and a target user device to obtain a D2D channel matrix, and then the UE would transmit the cellular channel matrix and the D2D channel matrix to the cellular transmitter.

According to one of the exemplary embodiments, the UE would receive from the cellular network device a transmission mode configuration based on the cellular channel matrix and the D2D channel matrix.

According to one of the exemplary embodiments, the transmission configuration would include a first precoding matrix and a second precoding matrix. The UE could then transmit signal over the cellular channel using the first precoding matrix and the D2D channel using the second precoding matrix.

According to one of the exemplary embodiments, the measurement of the cellular channel matrix would be performed over the first multiple-input multiple-output (MIMO) antenna channel between the UE and the transmitter of the cellular network device.

According to one of the exemplary embodiments, the transmission configuration would include a cellular channel matrix measured by the cellular network device based on a first multiple-input multiple-output (MIMO) antenna channel between the UE and the cellular network device and also a D2D channel matrix measured by the cellular network device based on a second MIMO antenna channel between the UE and a target user device.

According to one of the exemplary embodiments, the UE would perform interference cancellation of the first wireless signal and the second wireless signal based on the received transmission configuration from the cellular network device by making the first signal and the second signal orthogonal to each other in MIMO signal space.

According to one of the exemplary embodiments, the transmission configuration would include information to enable or disable the capability of a UE to receive the first wireless signal through the cellular connection and to receive the second wireless signal through the D2D connection using the multiple antennas.

According to one of the exemplary embodiments, the capability of simultaneous D2D and cellular transmission could be indicated by a system information block (SIB).

According to one of the exemplary embodiments, wherein the first wireless signal through the cellular connection and the second wireless signal through the D2D connection are received by the UE simultaneously.

According to one of the exemplary embodiments, the second wireless signal through the D2D connection is received by the UE over a uplink frequency band defined by a version of the Long Term Evolution (LTE) communication standard.

The present disclosure proposes a concurrent cellular and device to device (D2D) communication method applicable to a base station having multiple antennas, and the method would include at least but not limited to the base station establishing a cellular connection with a first UE, performing a first channel measurement of the cellular connection, receiving a second channel measurement of a D2D connection, wherein the cellular connection and the D2D connection are on the same frequency spectrum, configuring a transmission configuration based on the first channel measurement and the second channel measurement, and transmitting the transmission configuration to at least the first UE to cancel the interference between the cellular connection and the D2D connection.

According to one of the exemplary embodiments, transmitting the transmission configuration to at least the first UE would further include transmitting another transmission configuration to a second UE which engages in the D2D connection.

According to one of the exemplary embodiments, wherein the transmission configuration would include a first pre-coding matrix and the another transmission configuration would include a second pre-coding matrix such that the first pre-coding matrix and the second pre-coding matrix result in orthogonality between the cellular connection and the D2D connection assuming that the first pre-coding matrix is for the cellular connection and the second pre-coding matrix is for the D2D connection.

According to one of the exemplary embodiments, the transmission configuration would be transmitted over a system information block (SIB), a physical layer signalling or a MAC layer signalling.

The present disclosure also proposes a communication system which includes at least but not limited to a base station, a first user equipment (UE), a second UE, and a third UE, and the system would perform functions including at least but not limited to the base station establishing a cellular connection with the first UE, the second UE establishing a device to device (D2D) connection with a third UE, wherein the second UE and the third UE both may have multiple antennas, the base station transmitting a transmission configuration to the second UE, the base station transmitting a first wireless signal to the first UE through the cellular connection and the second UE transmits to the third UE a second wireless signal through the D2D connection using the multiple antennas, wherein the first wireless signal and the second wireless signal are transmitted over the same resource such as the same frequency, and the third UE performing interference cancellation of the wanted second wireless signal from the interfering first wireless signal based on the received transmission configuration from the cellular network device.

According to one of the exemplary embodiments, the base station would obtain a first channel matrix by measuring a first multiple-input multiple-output (MIMO) antenna channel between the base station and the first UE, and the base station would also obtain a second channel matrix by measuring a second multiple-input multiple-output (MIMO) antenna channel between the base station and the second UE.

According to one of the exemplary embodiments, the third UE would obtain a third channel matrix by measuring a third multiple-input multiple-output (MIMO) antenna channel between the third UE and the first UE, the third UE would obtain a fourth channel matrix by measuring a fourth multiple-input multiple-output (MIMO) antenna channel between the third UE and the second UE, and the third UE would then transmit the third channel matrix and the fourth channel matrix to the base station.

According to one of the exemplary embodiments, in response to receiving the third channel matrix and the fourth channel matrix, the base station would transmit a first transmission configuration to the first UE and a second transmission configuration for the second UE, wherein the information contained in first transmission configuration and the second transmission configuration are determined based on first channel matrix, second channel matrix, third channel matrix, and the fourth channel matrix.

According to one of the exemplary embodiments, the first transmission configuration would include a first precoding matrix so that the first UE transmits the first wireless signal using the first precoding matrix, and the second transmission configuration would include a second precoding matrix so that the second UE transmits the second wireless signal using the second precoding matrix.

According to one of the exemplary embodiments, the third UE would perform interference cancellation of the second wireless signal from the first wireless signal based on the received transmission configuration from the cellular network device comprising by rotating the phase of the second wireless signal to be orthogonal with the phase of the first wireless signal.

According to one of the exemplary embodiments, the transmission configuration would include information to enable or disable concurrent cellular connection and D2D connection.

According to one of the exemplary embodiments, the transmission configuration broadcasted from the base station in a system information block (SIB). The transmission configuration could indicate at least but not limited to the capability to simultaneously support D2D and cellular transmission.

According to one of the exemplary embodiments, the UE would use multiple antennas to transmit data through cellular connection and D2D connection simultaneously.

According to one of the exemplary embodiments, the second wireless signal through the D2D connection would be received over a uplink frequency band defined by a version of the Long Term Evolution (LTE) communication standard.

In order to make the aforementioned features and advantages of the present disclosure comprehensible, preferred embodiments accompanied with figures are described in detail below. It is to be understood that both the foregoing general description and the following detailed description are exemplary, and are intended to provide further explanation of the disclosure as claimed.

It should be understood, however, that this summary may not contain all of the aspect and embodiments of the present disclosure and is therefore not meant to be limiting or restrictive in any manner. Also the present disclosure would include improvements and modifications which are obvious to one skilled in the art.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1A illustrates a conventional cellular communication between a UE and a base station.

FIG. 1B illustrates a device-to-device (D2D) communications between two UEs.

FIG. 2 is an exemplary illustration serving to elucidate a proposed concept in accordance with the present disclosure.

FIG. 3A illustrates a concurrent cellular transmission and D2D transmission among a base station and two UEs using multiple antennas in accordance with one of the exemplary embodiments of the present disclosure.

FIG. 3B illustrates a concurrent cellular transmission and D2D transmission without interference mitigation in accordance with one of the exemplary embodiments of the present disclosure.

FIG. 3C illustrates a concurrent cellular transmission and D2D transmission using an interference mitigation technique in accordance with one of the exemplary embodiments of the present disclosure.

FIG. 4A is a flow chart which illustrates a procedure of concurrent cellular transmission and D2D transmission in accordance with one of the exemplary embodiments of the present disclosure.

FIG. 4B is a flow chart which illustrates a procedure of concurrent cellular transmission and D2D transmission through a centralized control in accordance with one of the exemplary embodiments of the present disclosure.

FIG. 5 is a flow chart which illustrates a concurrent cellular transmission and D2D transmission from the perspective of a user equipment in accordance with one of the exemplary embodiments of the present disclosure.

FIG. 6 is a flow chart which illustrates a concurrent cellular transmission and D2D transmission from the perspective of a base station in accordance with one of the exemplary embodiments of the present disclosure.

FIG. 7 illustrates a flow chart which illustrates a concurrent cellular transmission and D2D transmission from the perspective of a communication system in accordance with one of the exemplary embodiments of the present disclosure.

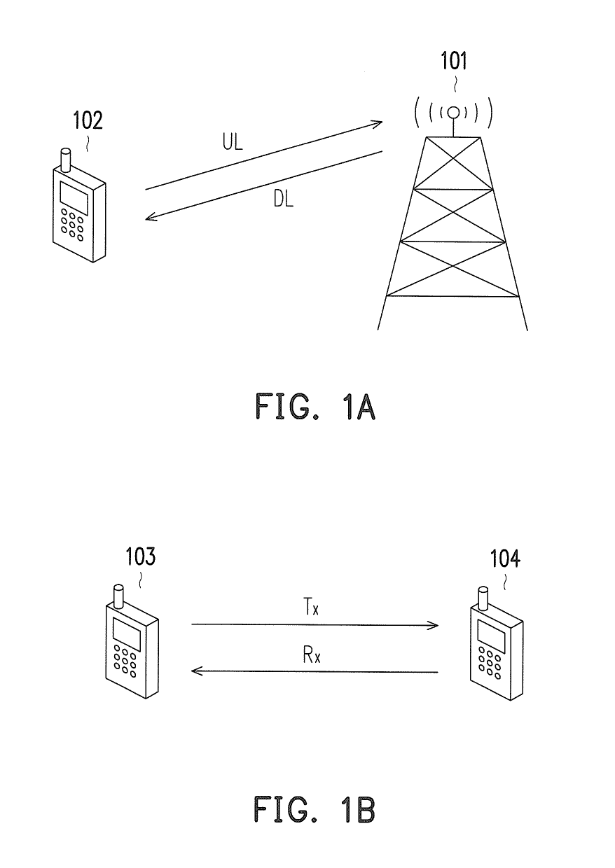

### DETAILED DESCRIPTION OF DISCLOSED EMBODIMENTS

Reference will now be made in detail to the present preferred embodiments of the disclosure, examples of which are illustrated in the accompanying drawings. Wherever possible, the same reference numbers are used in the drawings and the description to refer to the same or like parts.

As base stations or eNBs and UEs may have multiple antennas, parallel transmissions of multiple data streams could be implemented in a multi-antenna communication system. One of the basic principles of this disclosure would be to leverage MIMO spatial multiplexing in order to achieve concurrent cellular transmission and D2D transmission. The concurrent data transmissions would also be improved by applying appropriate signaling processing techniques.

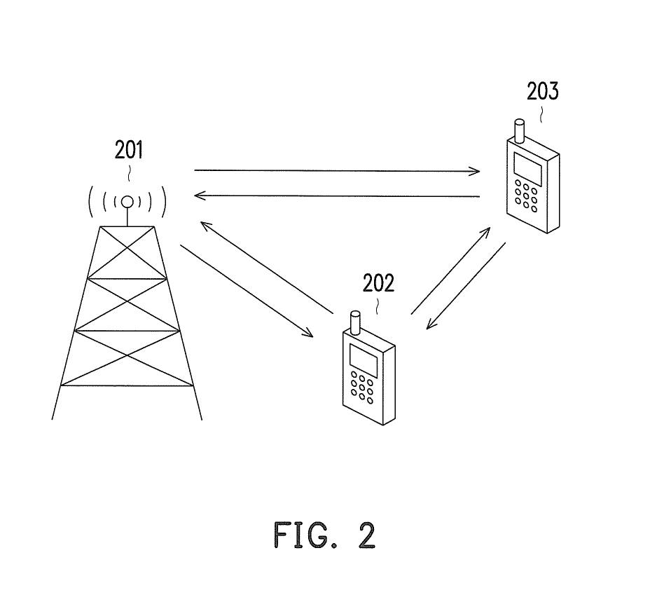

FIG. 2 illustrates is an exemplary scenario serving to elucidate a proposed concept in accordance with the present disclosure. According to FIG. 2, a base station or an eNB in the case of LTE could communicate with a first UE 202 and a second UE 203. Moreover, because both the first UE 202 and the second UE 203 could have two or more antennas, concurrent transmission of the conventional uplink cellular transmission and the D2D transmission would be possible. In other words, the transmission of D2D communications signals and the transmission of cellular signals could completely or partially overlap in time by sharing the same frequency spectrum. This means that both the first UE 202 and the second UE 203 could have direct interaction with each other while both the first UE 202 and the second UE 203 could also undergo data transmission with the base station. The number of simultaneous data transmission would not be limited to just one cellular communication and one D2D communication concurrently as the number of simultaneous data transmission could be increased according to the number of transmitting and receiving antennas as well as the MIMO channel. The interferences as the result of the concurrent transmissions would then need to be mitigated by applying MIMO signal processing techniques to improve the signals received across various MIMO channels.

The interference could be reduced through various means. For example, first UE 202 or the second UE 203 which engages in a D2D communication could each select a pre-coding configuration in order to reduce interference caused by the cellular communication with a base station. Otherwise, the first UE 202 or the second UE 203 could each obtain a pre-coding configuration from a serving base station which calculates in advance that the pre-coding configuration would minimize interference of the D2D channel and the cellular channel. As an example, the base station 201 which has a plurality of antennas could use signal processing techniques to reduce interference. The signal processing techniques could be at least any one of maximal ratio combining, interference cancellation, or nulling interference by rotating intended signal to the orthogonal signal space. The proposed scheme could be applied in conjunction with MIMO signal processing techniques such as precoding, space-time coding, spatial multiplexing, and etc.

The proposed communication scheme would include a measurement and feedback mechanism for multi-antenna channel matrix and/or pre-coding matrix. The feedback mechanism would report information such as a MIMO channel matrix, a precoding index, or any other channel state information among user equipments and base stations. The reporting mechanism could be a closed-looped feedback or an open-looped and may re-use the conventional MIMO feedback mechanism.

The proposed communication scheme could also include a configuration mechanism for the concurrent D2D communications and cellular communications. This means that a controlling network entity in the access stratum (AS) domain such as a radio controller or in the non-access stratum (NAS) domain such as a mobility management entity (MME) could configure a base station or eNB to support the concurrent cellular transmission and D2D transmission. A controlling network entity could also optimize the coordination and the concurrent transmissions among different cells. A base station or eNB could configure user equipments for concurrent transmissions over a wireless interface.

As the proposed scheme would include both D2D transmission and cellular transmission, the configuration of the transmission mode could be to jointly commence a D2D transmission and a cellular transmission. The configuration could also commence the D2D transmission first, and then adjust cellular transmission according to the existing D2D transmission and the MIMO channel conditions. Otherwise, the configuration could also be made to commence the cellular transmission first and then adjust D2D transmission according to the existing cellular transmission and the MIMO channel conditions.

The proposed communication scheme would also include control a signaling mechanism and a message format to enable the configuration of the transmission. The network may indicate the existence of the proposed service in the control signaling such as by using a system information block (SIB) to indicate such a service. The policy and configuration could be included in a control channel. A base station may describe the configuration of the proposed service to a user equipment such as through a MAC layer signaling or through the RRC signaling. A UE likewise may indicate its interest in the proposed service to its serving base station via a physical layer signal or a MAC layer signal. A base station may also make configuration decisions based on the feedback for the MIMO channel state or other CSI feedback from UEs. Embodiments of the proposed concept would be explained as follows.

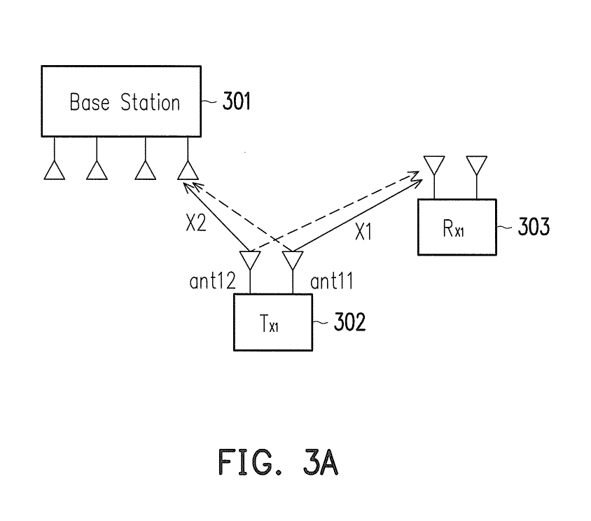

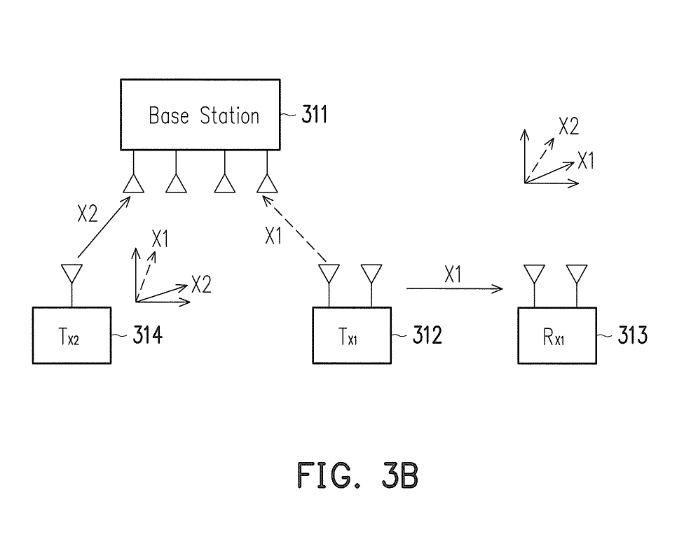

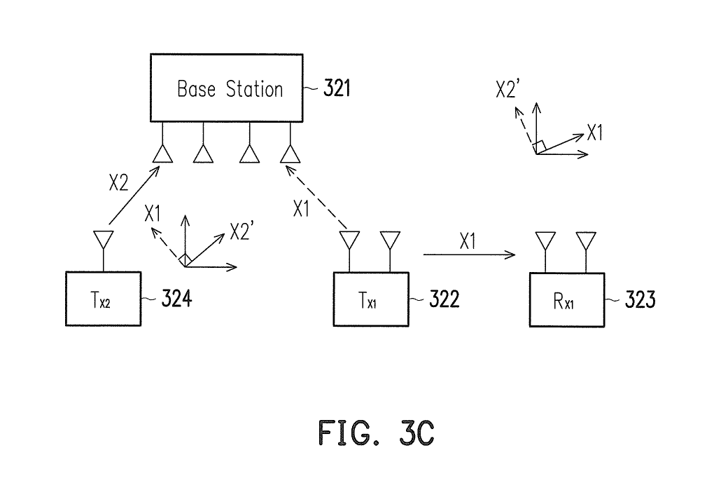

FIG. 3A illustrates an embodiments of a concurrent cellular transmission and D2D transmission involving a base station and two UEs using multiple antennas in accordance with one of the exemplary embodiments of the present disclosure. In FIG. 3A, a base station 301 could engage in a cellular transmission with a first UE 302 which could engage in a joint cellular transmission with the base station 301 and D2D transmission with a second UE 303. The first UE 302 in this example could be a D2D transmitter and a cellular transmitter at the same time, and the second UE 303 would be the D2D receiver; however, the roles of the first UE 302 and the second UE 303 could be reversed as the first UE 302 could be the receiver and the second UE 303 could be the transmitter. In FIG. 3A, the transmitter, Tₓ₁, of the first UE 302 has two antennas, namely, ant₁₁ and ant₁₂. Multi-antenna spatial multiplexing could utilize both antennas ant₁₁ and ant₁₂ to enable a concurrent data transmission for D2D stream, x₁, to the receiver of the second UE 303, Rₓ₁ and for cellular stream, x₂, to the base station 301. The MIMO multiplexing and other multi-antenna signal processing technique could be applied so that the two data streams x₁ and x₂ could be received with better signal integrity at the receivers of UE2 303 and the base station 301, respectively.

The aforementioned MIMO multiplexing and other multi-antenna signal processing technique could involve rotating the phase of the signals in the two data streams x₁ and x₂ such that, in the signal space, the data streams x₁ and x₂ would be substantially or completely orthogonal with each other. This means that the base station 301 could measure the channels of the two data streams x₁ and x₂ or rely on the first UE 302 and/or the second UE 303 to perform and to feedback the channel measurement. The base station 301 could then assign a precoding configuration or allows the first UE 302 to adopt its own precoding configuration. The precoding configuration could rotate the phase of the two data streams x₁ and x₂ such that, in the signal space, the data streams x₁ and x₂ would be substantially or completely orthogonal with each other. This would minimize the interference between the data streams x₁ and x₂.

Some feedback might not needed because the first UE 302 could transmit D2D data stream and uplink cellular data stream at the same time. Some of the channel measurement may re-use the conventional cellular communication channel measurement procedures or results which could be obtained by a previous cellular data transmission. The feedback mechanism could modify the conventional MIMO feedback mechanism or create a new feedback mechanism for the proposed service. Some of the signaling feedback may re-use or share with the conventional cellular communication channel measurement procedures.

FIG. 3B illustrates another embodiment of a concurrent cellular transmission and D2D transmission. For this particular scenario, the D2D transmitter Tₓ₁ 312 and the cellular transmitter Tₓ₂ 314 are situated in two different UEs. When the cellular transmitter Tₓ₁ 314 transmits a cellular data stream x₂ to the base station 311 over a cellular channel, the D2D transmitter Tₓ₁ 312 may transmit a D2D data stream x₁ to a receiver Rₓ₁ 313 over a D2D channel. However, the D2D stream x₁ might not only be received by the receiver Rₓ₁ 313 over the D2D channel but might also be received by the base station 311 and thus would cause interference between the data streams x₁ and x₂ without any interference mitigation, assuming that x₁ and x₂ are transmitted over the same carrier frequency or over the same frequency band. Similarly, at the receiver Rₓ₁ 313, the data stream x₁ which would be wanted by the receiver Rₓ₁ 313 might be interfered by the cellular data stream x₂. Also at the base station 311, the cellular uplink data stream x₂ might be interfered by D2D data stream x₁.

The scenario of FIG. 3C would be similar to the scenario of FIG. 3B except that an interference mitigation technique has been applied in accordance with one of the exemplary embodiments of the present disclosure. At the D2D receiver Rₓ₁ 323, one interference mitigation technique might be to rotate the interfering x₂ which originates from the cellular transmitter Tₓ₂ 324 to be become the cellular data stream x₂′ in order to be orthogonal to the intended data stream x₁ which originates from the D2D transmitter Tₓ₁ 322. Similarly, at the base station 321, the intended data stream x₂ and interfering data stream x₁ could be processed to be orthogonal (i.e. to become x1 and x₂′ in FIG. 3C). The orthogonality between data streams x₁ and x₂′ could be imposed by the use of a precoding matrix to rotate the data streams x₁ and x₂ in the MIMO signal space. The precoding matrix could be assigned by the base station 321 to one or more of the UE 324, UE 322, and UE 323. In this scenario, the base station 321 could perform the channel measurements of the channel in which the data stream x₂ is transmitted or rely on the UE 324 to report the channel measurement. The UE 322 could perform the channel measurement of the channel in which the data stream x₁ is transmitted from the UE 322 to the UE 323. By knowing the channel measurements, the base station 321 could then make the decision as to what precoding configuration should be used. The precoding configuration could be based on an existing codebook of a LTE communication system.

Examples of interference mitigation techniques to mitigate interference between a concurrent D2D communication and an uplink cellular communication could include nulling, interference alignment, MIMO precoding matrix selection, and signal rotation.

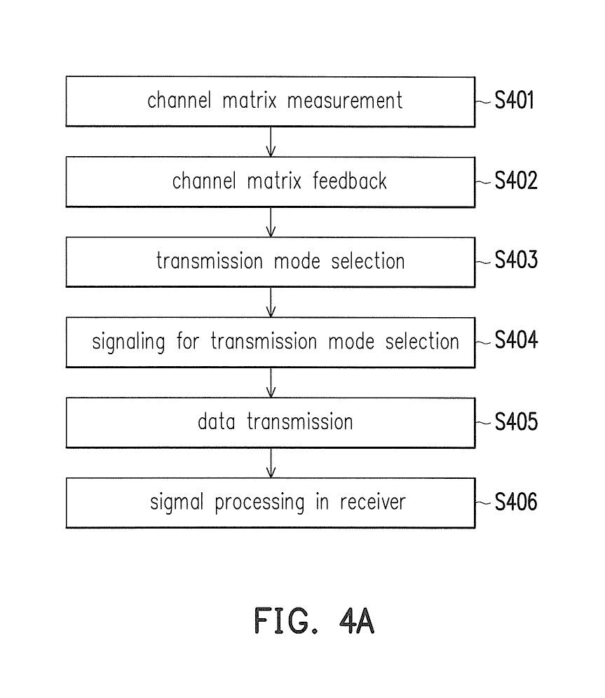

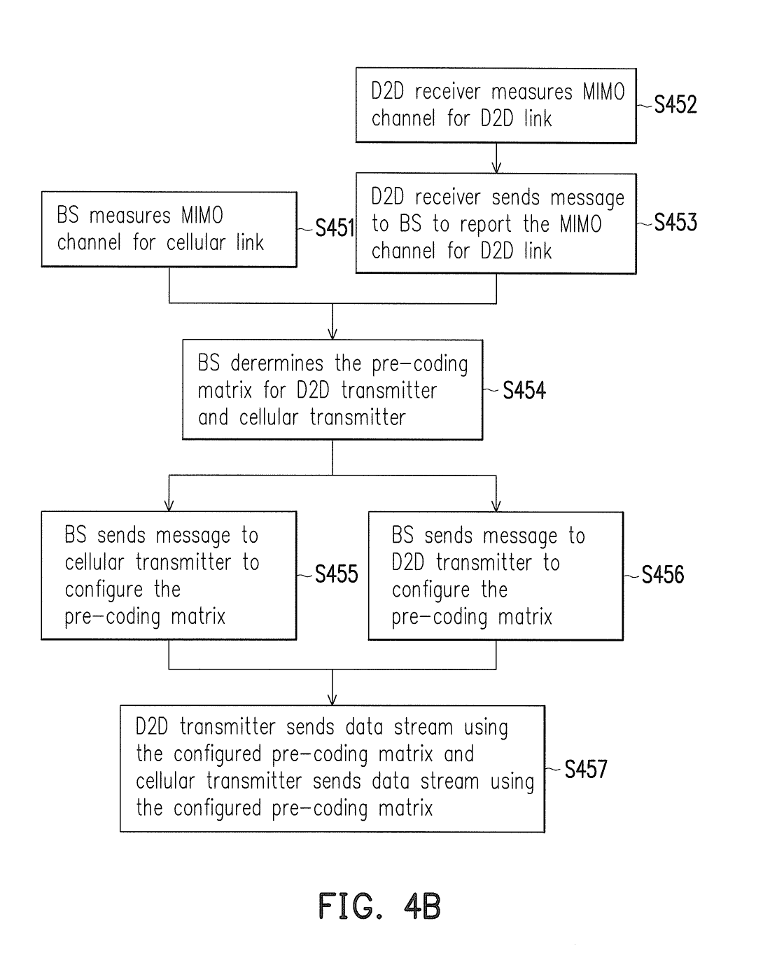

The scenarios of FIGS. 3A and 3B could further be implemented according to the procedure of FIGS. 4A and 4B which illustrate a procedure of concurrent cellular transmission and D2D transmission in accordance with one of the exemplary embodiments of the present disclosure. In step S401, a channel matrix measurement would be performed. In particular, a base station or eNB could measure the MIMO channel between a cellular transmitter in the user's end and the base station. For the present disclosure, the channel matrix could be denoted as H[tₓ₂→BS]. For example, the scenario of FIG. 3B, the H[tₓ₂→BS] would be measured between the base station 311 and the cellular transmitter Tₓ₂ 314. A base station or eNB could measure between a D2D transmitter and a base station the MIMO channel in which the channel matrix could be denoted as H[tₓ₁→BS]. For the scenario of FIG. 3B, the H[tₓ₁→BS] would be measured between the base station 311 and the D2D transmitter Tₓ₁ 312.

A D2D receiver could measures between a cellular transmitter and a D2D receiver the MIMO channel, for which the channel matrix might be denoted as H[tₓ₂→rₓ₁]. For the scenario of FIG. 3B, the H[tₓ₂→rₓ₁] would be measured between the cellular transmitter Tx2 314 and the receiver Rₓ₁ 313. A D2D receiver could measures between a D2D transmitter and a D2D receiver the MIMO channel, in which the channel matrix might be denoted as H[tₓ₁→rₓ₁]. For the scenario of FIG. 3B, the H[tₓ₁→rₓ₁] would be measured between the D2D transmitter Tₓ₁ 312 and the receiver Rₓ₁ 313. It should be noted that for the above mentioned MIMO channel measurements, these measurements could be performed in any order.

In step S402, the above mentioned channel matrix would be feedback through a signal message. The feedback mechanism would report information such as a MIMO channel matrix, a precoding index, or any other channel state information among user equipments and base stations. The reporting mechanism could be a closed-looped feedback or an open-looped and may re-use the conventional MIMO feedback mechanism. The proposed communication scheme would also include control a signaling mechanism and a message format to enable the configuration of the transmission. The network may indicate the existence of the proposed service in the control signaling such as by using a system information block (SIB) to indicate such a service. The policy and configuration could be included in a control channel. A base station may describe the configuration of the proposed service to a user equipment such as through a MAC layer signaling or through the RRC signaling. A UE likewise may indicate its interest in the proposed service to its serving base station. A base station may also make configuration decisions based on the feedback for the MIMO channel state or other CSI feedback from UEs.

In step S403, a transmission mode selection would be selected in response to the channel matrix measurement in step S401 and/or the channel matrix feedback S402 from user devices to a base station. The transmission mode selection may include a selection of pre-coding matrix. The pre-coding matrix could be selected by a base station or be selected by individual user devices. In a base station central decision model, a base station may transmit a downlink stream using a predefined pre-coding matrix from an existing LTE codebook or a customized codebook, and the base station may assign a pre-coding matrix to one or more user devices.

In step S404, signaling for transmission mode configuration would be performed. Unless the transmission mode selection of step S403 is performed at the cellular transmitter or D2D transmitter of user devices, the signaling message to deliver the transmission mode selection result might be needed. The signaling message could be delivered via a MAC layer message, a physical layer message, or through a periodic SIB message. In step S405, data transmission would be performed. This would mean that one or more D2D data streams could be concurrently transmitted with one or more cellular data streams. In step S406, signal processing at the receiver would be performed. One technique which could be used to improve the reception quality is to rotate the received signal based on the selected or assigned pre-coding matrix. The pre-coding matrix could rotate the signal space of a signal such that two signals could be orthogonal with each other. Other techniques that can be used would include Maximal Ratio Combining, Interference cancellation (e.g. nulling), Interference alignment, and so forth.

FIG. 4B is a flow chart which illustrates a concurrent cellular transmission and D2D transmission through a centralized control in accordance with one of the exemplary embodiments of the present disclosure. In step S451, a base station could measure the MIMO channel of a cellular link. In step S452, a D2D receiver could measure the MIMO channel for a D2D link, and then in step S453, the D2D receiver could deliver a message to the base station to report the MIMO channel of the D2D link. Steps S451 and S453 could be performed at different times, and one could proceed the other. In step S454, the base station could determine the pre-coding matrix for a D2D transmitter and a cellular transmitter. In step S455, the base station could deliver a message to the cellular transmitter to configure a pre-coding matrix. In step S456, the base station could send a message to the D2D transmitter to configure the pre-coding matrix. Steps S455 and S456 could be performed at different times, and one could proceed the other. In step S457, the D2D transmitter could send data stream using the configured pre-coding matrix, and the cellular transmitter could send data stream using the configured pre-coding matrix.

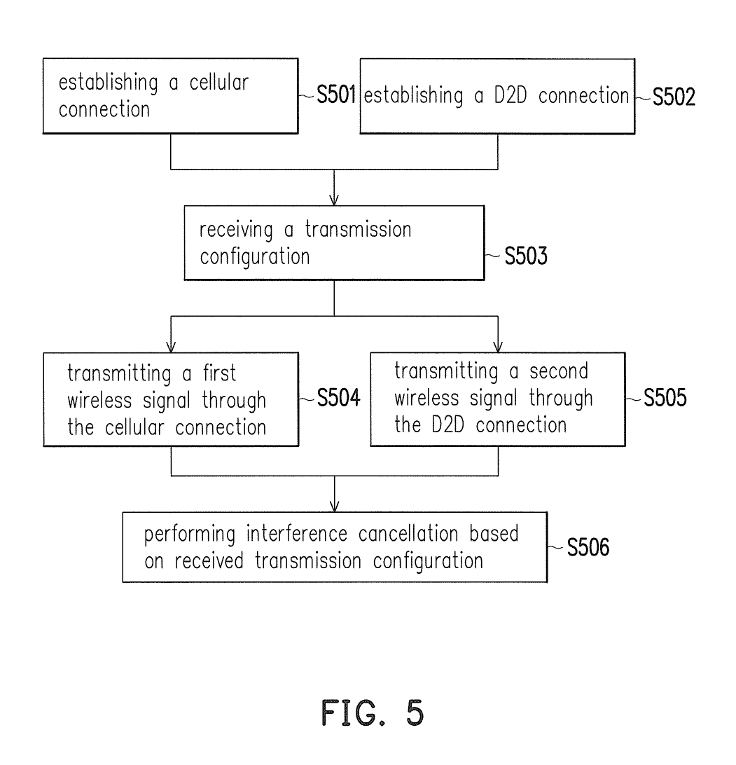

FIG. 5 is a flow chart which illustrates a concurrent cellular transmission and D2D transmission from the perspective of a user equipment in accordance with one of the exemplary embodiments of the present disclosure. In steps S501 and S502, a UE may establish a concurrent D2D connection with another peer user device and a cellular connection with a base station respectively. In step S503, the UE may receive a transmission configuration from the base station. The transmission configuration may include at least a pre-coding matrix. In steps S504 and S505, a UE may respectively transmit a first wireless signal through the cellular connection and transmit a second wireless signal through the D2D connection concurrently. In step S506, the UE may perform interference cancellation based on the received transmission configuration. For example, the UE may use a pre-coding matrix to rotate at least one of the first wireless signal and the second wireless signal such that the first wireless signal and the second wireless signal are orthogonal with each other.

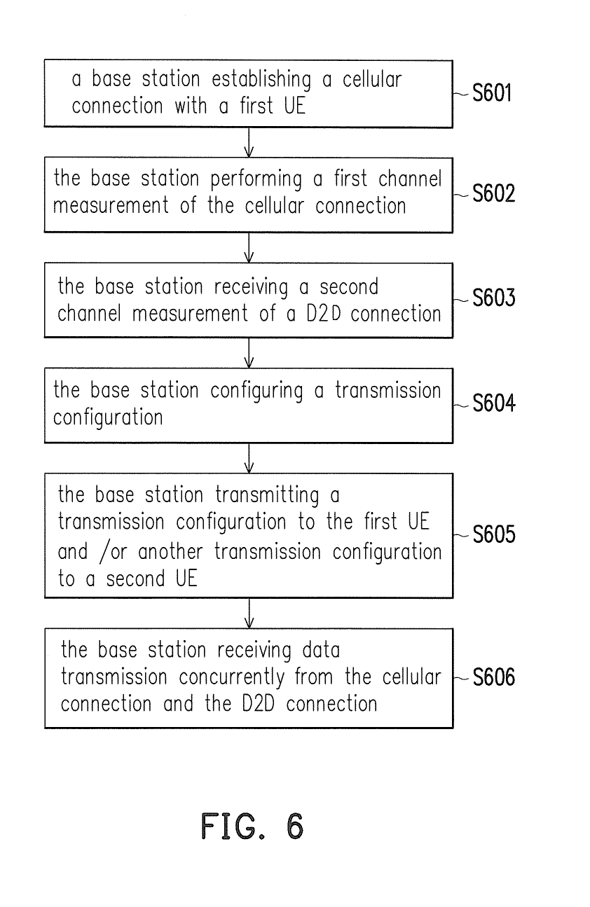

FIG. 6 illustrates a flow chart which illustrates a concurrent cellular transmission and D2D transmission from the perspective of a base station in accordance with one of the exemplary embodiments of the present disclosure. In step S601, a base station may establish a cellular connection with a first UE. In step S602, the base station may perform a first channel measurement of the cellular connection. In step S603, the base station may receive a second channel measurement of a D2 D connection. In step S604, the base station may configure a transmission configuration which may include pre-coding configurations for the cellular connection and the D2D connection. In step S605, the base station may transmit a transmission configuration to the first UE and/or another transmission configuration to a second UE. The first UE and the second UE would perform signal processing based on the transmission configuration. In step S606, the base station would receive data transmission concurrently from the cellular connection and the D2D connection.

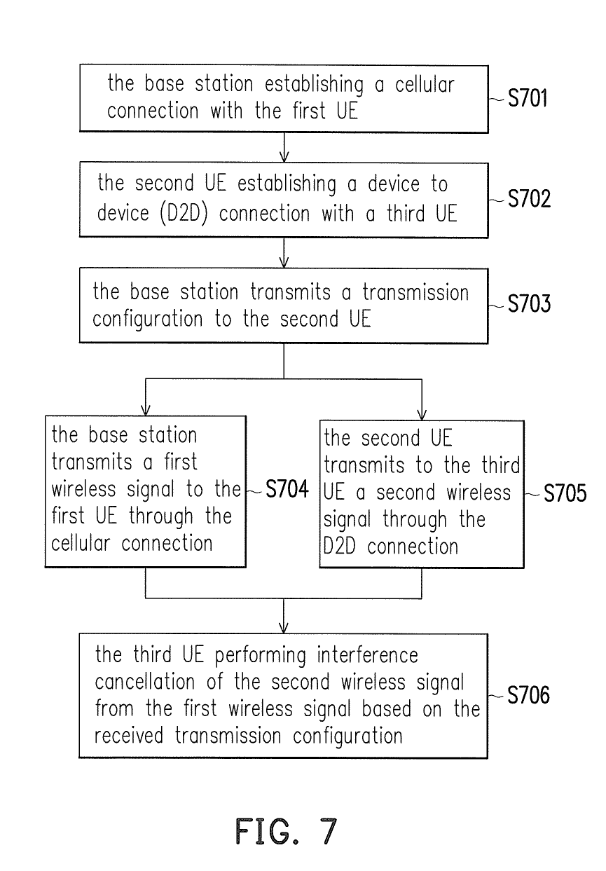

FIG. 7 illustrates a flow chart which illustrates a concurrent cellular transmission and D2D transmission from the perspective of a communication system in accordance with one of the exemplary embodiments of the present disclosure. In step S701, the base station would establish a cellular connection with a first UE. In step S702, the second UE would establish a D2D connection with a third UE. Steps S701 and S702 could be performed in any order. In step S703, the base station would transmit a transmission configuration to the second UE. Step S703 could be performed in response to channel measurement. For example, the cellular channel between the base station and the first UE could be measured by either the base station or the first UE. The D2D channel could be measured by the second UE or the third UE and reported back to the base station. In step S704, the base station could transmit a first wireless signal to the first UE through the cellular connection. In step S705, the second UE could transmit to the third UE a second wireless signal through the D2D connection. It should be noted that the sequence of step S704 and S705 would be interchangeable or could also occur simultaneously. In step S706, the third UE would perform interference cancellation of the second wireless signal from the first wireless signal based on the received transmission configuration, which may include a pre-coding configuration, or MIMO channel matrix.

In view of the aforementioned descriptions, the present disclosure is suitable for being used in a wireless communication system and is able to implement a concurrent D2D transmission and cellular transmission using MIMO antenna technology by minimizing the interference between the D2D transmission and the cellular transmission.

No element, act, or instruction used in the detailed description of disclosed embodiments of the present application should be construed as absolutely critical or essential to the present disclosure unless explicitly described as such. Also, as used herein, each of the indefinite articles “a” and “an” could include more than one item. If only one item is intended, the terms “a single” or similar languages would be used. Furthermore, the terms “any of” followed by a listing of a plurality of items and/or a plurality of categories of items, as used herein, are intended to include “any of”, “any combination of”, “any multiple of”, and/or “any combination of multiples of” the items and/or the categories of items, individually or in conjunction with other items and/or other categories of items. Further, as used herein, the term “set” is intended to include any number of items, including zero. Further, as used herein, the term “number” is intended to include any number, including zero.

In this disclosure, 3GPP-like keywords or phrases are used merely as examples to present inventive concepts in accordance with the present disclosure; however, the same concept presented in the disclosure can be applied to any other systems such as IEEE 802.11, IEEE 802.16, WiMAX, and so like by persons of ordinarily skilled in the art.

In this disclosure, it would be apparent for an ordinary person skilled in the art that a base station (BS) or an eNB could also be an advanced base station (ABS), a base transceiver system (BTS), an access point, a home base station, a relay station, a repeater, an intermediate node, an intermediary, and/or satellite-based communication base stations.

The functions described for base station could also be implemented in entities such as a Mobility Management Entity (MME), a Serving Gateway (S-GW), a Packet Data Network Gateway (PDN-GW), a Serving GPRS Support Node (SGSN), a Gateway GPRS Support Node (GGSN), a Mobile Switching Center (MSC), and a Home Subscriber Server (HSS) or a node maintaining a database related to subscriber information.

From the hardware perspective, a base station may contain at least but not limited to a transmitter circuit, a receiver circuit, an analog-to-digital (A/D) converter, a digital-to-analog (D/A) converter, a processing circuit, one or more antenna units, and a storage medium. The transmitter and the receiver transmit downlink signals and receive uplink signals wirelessly. The receiver may include functional elements to perform operations such as low noise amplifying, impedance matching, frequency mixing, down frequency conversion, filtering, amplifying, and so forth. The transmitter may include function elements to perform operations such as amplifying, impedance matching, frequency mixing, up frequency conversion, filtering, power amplifying, and so forth. The analog-to-digital (A/D) or the digital-to-analog (D/A) converter is configured to convert from an analog signal format to a digital signal format during uplink signal processing and from a digital signal format to an analog signal format during downlink signal processing.

The processing circuit is configured to process digital signal and to perform procedures related to the proposed method in accordance with exemplary embodiments of the present disclosure. Also, the processing circuit may optionally be coupled to a memory circuit to store programming codes, device configurations, a codebook, buffered or permanent data, and etc. . . . . The functions of the processing circuit may be implemented using programmable units such as a micro-processor, a micro-controller, a DSP chips, FPGA, etc. The functions of the processing circuit may also be implemented with separate electronic devices or ICs, and the processing circuit may also be implemented with either hardware or software.

The term “user equipment” (UE) in this disclosure could represent various embodiments which for example could include but not limited to a mobile station, an advanced mobile station (AMS), a server, a client, a desktop computer, a laptop computer, a network computer, a workstation, a personal digital assistant (PDA), a tablet personal computer (PC), a scanner, a telephone device, a pager, a camera, a television, a hand-held video game device, a musical device, a wireless sensor, and so like. In some applications, a UE may be a fixed computer device operating in a mobile environment, such as a bus, train, an airplane, a boat, a car, and so forth.

From the hardware perspective, a UE may also be referred to as an apparatus which includes at least but not limited to a transmitter circuit, a receiver circuit, an analog-to-digital (A/D) converter, a digital-to-analog (D/A) converter, a processing circuit, one ore more antenna units, and optionally a memory circuit. The memory circuit may store programming codes, device configurations, buffered or permanent data, codebooks, and etc. . . . . The processing circuit may also be implemented with either hardware or software. The function of each element of a UE would be similar to what was described for a base station and thus detailed descriptions for each element will not be repeated.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

Moreover, the claims should not be read as limited to the described order or elements unless stated to that effect. In addition, use of the term “means” in any claim is intended to invoke 35 U.S.C. §112, ¶6, and any claim without the word “means” is not so intended.

What is claimed is:

1. A concurrent cellular and device to device (D2D) communication method applicable to a user equipment (UE) comprising multiple antennas, and the method comprising:
establishing a cellular connection with a cellular network device and establishing a D2D connection with a target user device;
receiving a transmission configuration from the cellular network device;
receiving a first wireless signal through the cellular connection and a second wireless signal through the D2D connection using the multiple antennas, wherein the first wireless signal and the second wireless signal are received over the same frequency; and
performing interference cancellation of the first wireless signal and the second wireless signal based on the received transmission configuration from the cellular network device.

2. The method of claim 1, wherein before receiving the transmission configuration from the cellular network device, claim 1 further comprising:
measuring a first multiple-input multiple-output (MIMO) antenna channel between the UE and the cellular network device to obtain a cellular channel matrix;
measuring a second MIMO antenna channel between the UE and a target user device to obtain a D2D channel matrix; and
transmitting the cellular channel matrix and the D2D channel matrix to the cellular transmitter.

3. The method of claim 2 further comprising:
receiving from the cellular network device a transmission mode configuration based on the cellular channel matrix and the D2D channel matrix.

4. The method of claim 2 wherein measuring the first multiple-input multiple-output (MIMO) antenna channel between the UE and the cellular network device to obtain a cellular channel matrix further comprising:
measuring the first multiple-input multiple-output (MIMO) antenna channel between the UE and the transmitter of the cellular network device to obtain a cellular channel matrix; and transmitting a channel state information to the cellular transmitter.

5. The method of claim 1 wherein the transmission configuration comprises a cellular channel matrix based on a first multiple-input multiple-output (MIMO) antenna channel between the UE and the cellular network device, a D2D channel matrix based on a second MIMO antenna channel between the UE and a target user device, a cellular channel precoding matrix, and a D2D channel precoding matrix.

6. The method of claim 5, wherein performing interference cancellation of the first wireless signal and the second wireless signal based on the received transmission configuration from the cellular network device comprising:
performing signal processing for the first signal and the second signal based on the received transmission configuration from the cellular network device by making the first signal and the second signal orthogonal to each other.

7. The method of claim 1, wherein the transmission configuration is received from a system information block (SIB), a physical layer signalling or a MAC layer signaling.

8. The method of claim 1, wherein the first wireless signal through the cellular connection and the second wireless signal through the D2D connection are received simultaneously.

9. A concurrent cellular and device to device (D2D) communication method applicable to a base station comprising multiple antennas, and the method comprising:
establishing a cellular connection with a first user equipment (UE);
performing a first channel measurement of the cellular connection;
receiving a second channel measurement of a D2D connection, wherein the cellular connection and the D2D connection are on the same frequency spectrum;
configuring a transmission configuration based on the first channel measurement and the second channel measurement; and
transmitting the transmission configuration to at least the first UE to cancel the interference between the cellular connection and the D2D connection.

10. The method of claim 9, wherein transmitting the transmission configuration to at least the first UE further comprising:
transmitting another transmission configuration to a second UE which engages in the D2D connection.

11. The method of claim 10, wherein the transmission configuration comprises a first pre-coding matrix and the another transmission configuration comprises a second pre-coding matrix such that the first pre-coding matrix and the second pre-coding matrix result in orthogonality between the cellular connection and the D2D connection.

12. The method of claim 9, wherein the transmission configuration is transmitted over a system information block (SIB), a physical layer signalling or a MAC layer signalling.

13. A communication system comprising a base station, a first user equipment (UE), a second UE, and a third UE, and the system comprising:
the base station establishing a cellular connection with the first UE;
the second UE establishing a device to device (D2D) connection with a third UE, wherein the second UE and the third UE each comprises multiple antennas;
the base station transmits a transmission configuration to the second UE;
the base station transmits a first wireless signal to the first UE through the cellular connection and the second UE transmits to the third UE a second wireless signal through the D2D connection using the multiple antennas, wherein the first wireless signal and the second wireless signal are transmitted over the same frequency; and
the third UE performing interference cancellation of the second wireless signal from the first wireless signal based on the received transmission configuration from the cellular network device.

14. The system of claim 13 further comprising:
the base station obtaining a first channel matrix by measuring a first multiple-input multiple-output (MIMO) antenna channel between the base station and the first UE; and
the base station measuring a second channel matrix by measuring a second multiple-input multiple-output (MIMO) antenna channel between the base station and the second UE.

15. The system of claim 14 further comprising:
the third UE obtaining a third channel matrix by measuring a third multiple-input multiple-output (MIMO) antenna channel between the third UE and the first UE;
the third UE obtaining a fourth channel matrix by measuring a fourth multiple-input multiple-output (MIMO) antenna channel between the third UE and the second UE; and
the third UE transmitting the third channel matrix and the fourth channel matrix to the base station.

16. The system of claim 15 further comprising:
in response to receiving the third channel matrix and the fourth channel matrix, the base station transmitting a first transmission configuration to the first UE and a second transmission configuration for the second UE, wherein the first transmission configuration and the second transmission configuration are based on first channel matrix, second channel matrix, third channel matrix, and the fourth channel matrix.

17. The system of claim 16 wherein the first transmission configuration comprises a first precoding matrix so that the first UE transmits the first wireless signal using the first precoding matrix and the second transmission configuration comprises a second precoding matrix so that the second UE transmits the second wireless signal using the second precoding matrix.

18. The system of claim 17, wherein the third UE performing interference cancellation of the second wireless signal from the first wireless signal based on the received transmission configuration from the cellular network device comprising:
performing interference cancellation of the second wireless signal by rotating the phase of the second wireless signal to be orthogonal with the phase of the first wireless signal.

19. The system of claim 13, wherein the transmission configuration broadcasted from the base station in a system information block (SIB) or transmitted through a physical layer signalling or transmitted through a MAC layer signaling.

20. The system of claim 13, wherein the second user equipment uses multiple antennas to transmit data through cellular connection and D2D connection simultaneously.
